(19) United States
(12) Patent Application Publication
(10) Pub. No.: US 2021/0178231 A1
(43) Pub. Date: Jun. 17, 2021

(54) GOLF BALL AND METHOD OF MANUFACTURE

(71) Applicant: Bridgestone Sports Co., Ltd., Tokyo (JP)

(72) Inventor: Katsunobu MOCHIZUKI, Chichibushi (JP)

(73) Assignee: Bridgestone Sports Co., Ltd., Tokyo (JP)

(21) Appl. No.: 16/951,028

(22) Filed: Nov. 18, 2020

(30) Foreign Application Priority Data
Dec. 16, 2019 (JP) 2019-226473

(51) Int. Cl. A63B 37/00; C09D 175/08; C09D 175/06

(52) U.S. Cl. CPC A63B 37/00373; A63B 37/0027; A63B 37/0031; C09D 175/08; C09D 175/06; C08K 3/346; A63B 37/0096; A63B 37/00221; A63B 37/0075; A63B 37/0074; A63B 37/0033; A63B 37/0095

(57) ABSTRACT

In a golf ball having a cover layer that is formed of a resin material composed primarily of polyurethane or polyurea, the cover layer includes a colored surface portion having a visible light transmittance of at least 0.6%. A method for producing the golf ball includes the steps of forming the cover layer over a core or other target sphere and providing the colored surface portion by coloring the surface of the cover layer. The cover layer which includes the colored surface portion has a visible light transmittance of at least 0.6%. The golf ball has a surface with a distinctive aesthetic appearance and retains both a good spin performance and a good scuff resistance, making it useful as a ball for professional and skilled amateur golfers.

### CROSS-REFERENCE TO RELATED APPLICATION

This non-provisional application claims priority under 35 U.S.C. § 119(a) on Patent Application No. 2019-226473 filed in Japan on Dec. 16, 2019, the entire contents of which are hereby incorporated by reference,

### TECHNICAL FIELD

The present invention relates to a colored golf ball with a polyurethane cover whose surface has been color-treated. More specifically, the invention relates to a golf ball that has a distinctive aesthetic appearance and is able to retain both a good spin performance and a good scuff resistance, and to a method for manufacturing such a ball.

### BACKGROUND ART

Golf bails are required to possess, among other characteristics, a good flight and stopping performance and a good scuff resistance. Golf balls have thus been developed so as to fly well on shots with a driver and to be suitably receptive to backspin on approach shots. Cover materials with a high resilience and a good scuff resistance have been developed to date with this in mind. Recently, golf balls in which the cover material is a polyurethane material are favored by professional golfers and skilled amateurs. Also, aside from ordinary white golf balls, colored balls too have become popular among golfers.

Polyurethane resins, owing to their molecular structure, are generally translucent or cloudy in the uncolored state. To impart color, a pigment or dye is mixed in and kneaded with the resin. However, depending on the hue to which the resin is being colored, heating occurs during kneading of the resin composition and chemical reactions among constituents within the polyurethane resin itself arise, resulting in poor color development and a dull coloration. Also, when a resin material that has been colored with a dye is used, during golf ball manufacturing operations, the dye migrates into the resin-transporting lines and the like that are used, leading to undesirable outcomes such as contamination of the production equipment.

In terms of colored golf balls m which the cover material is made of polyurethane, yellow-colored and orange-colored balls already exist on the market. Although these colored golf balls do address a demand for colors other than white, they are ultimately colored balls for skilled golfers that are aimed at attributes such as visibility and spin performance.

Methods for coloring the cover material of a golf ball that have already been disclosed include methods in which a pigment or dye is mixed into a cover-forming resin material, and methods in which the surface of the cover is color treated. See, for example, the following literature: JP-A 2016-513488, JP-A 2016-513489, U.S. Patent Application No. 2014/256468, U.S. Patent Application No. 2014/250609, U.S. Patent Application No. 2018/080172, JP-A 2004-180921, JP-A 558-143769 and JP-A 558-112567.

### SUMMARY OF THE INVENTION

It is therefore an object of the present invention to provide a golf ball wherein the cover material includes a polyurethane resin as the base resin, which golf ball is endowed with the excellent scuff resistance and spin performance required by professional golfers and skilled amateurs, and also has a distinctive aesthetic appearance that is colored and highly visible.

As a result of extensive investigations, I have found that, in a golf ball having a cover layer formed of a polyurethane resin material, by coloring the surface of the cover layer so as to provide a colored surface portion and fabricating the golf ball such that the cover layer which includes this colored surface portion has a visible light transmittance of at least 0.6%, the surface of the ball exhibits the desired color tone and has a distinctive aesthetic appearance, plus the ball is able to maintain a good spin performance and good scuff resistance, making it useful as a golf ball for professional golfers and skilled amateurs,

Accordingly, in a first aspect, the invention provides a golf ball having a cover layer that is formed of a resin material composed primarily of polyurethane or polyurea, wherein the ball has a colored surface portion obtained by coloring a surface of the cover layer, and the cover layer which includes the colored surface portion has a visible light transmittance of at least 0.6%.

In a preferred embodiment of the golf ball according to the first aspect of the invention, the colored surface portion obtained by coloring the cover layer surface has a color tone differing from that of the resin material making up the cover layer.

In another preferred embodiment of this aspect of the invention, the golf ball having the colored surface portion-containing cover layer has a lightness (L* value) in the L*a*b* color space of at least 25.

In yet another preferred embodiment of the golf ball of the invention, the colored surface portion is colored with a dye.

In still another preferred embodiment of the inventive golf ball, the colored surface portion exists within 1.0 mm of the cover layer surface.

In a further preferred embodiment of this golf ball, the resin material of the cover layer has a Shore D hardness of not more than 60.

In a second aspect, the invention provides a method for producing a golf ball having a cover layer that is formed of a resin material composed primarily of polyurethane or polyurea, which method includes the steps of forming the cover layer over a core or other target sphere; and providing a colored surface portion by coloring a surface of the cover layer. In the ball obtained by this method, the cover layer which includes the colored surface portion has a visible light transmittance of at least 0.6%.

In a preferred embodiment of the production method according to the second aspect of the invention, the step of providing a colored surface portion includes the step of coloring the surface of the cover layer with a coloring solution. When coloring the surface of the cover layer with the coloring solution, the coloring solution may have a temperature of not more than 100° C. Also, when coloring the surface of the cover layer with the coloring solution, the coloring solution may have a contact time with the cover layer surface of from 1 minute to 24 hours. The coloring solution may be obtained by dissolving or dispersing a dye in a solvent. The step of providing the colored surface portion may include, after coloring the surface of the cover layer with the coloring solution, the step of removing excess coloring solution with a solvent. When the step of removing excess coloring solution with a solvent is included, the solvent used for removing excess coloring solution may be water or an alcohol.

### Advantageous Effects of the Invention

In the golf ball of the invention, and by virtue of the inventive method for producing such golf balls, the surface of the ball has a distinctive aesthetic appearance and the ball is able to retain both a good spin performance and a good scuff resistance, making it useful as a ball for professional golfers and skilled amateurs.

### BRIEF DESCRIPTION OF THE DIAGRAMS

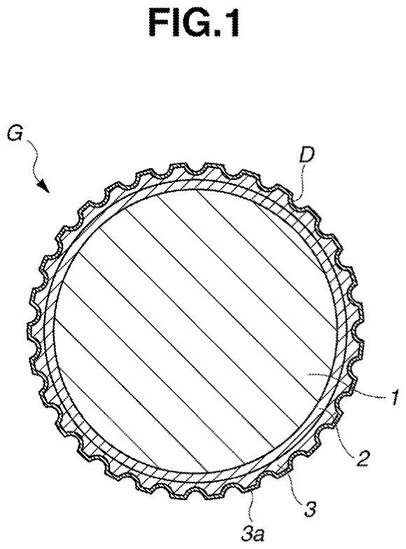

FIG. 1 is a schematic cross-sectional view of a golf ball having a cover layer that includes a colored surface portion according to one embodiment of the invention.

### DESCRIPTION OF THE PREFERRED EMBODIMENTS

The objects, features and advantages of the invention will become more apparent from the following detailed description taken in conjunction with the appended diagram.

The golf ball of the invention is a ball having a core and at least one cover layer. The outermost layer of the cover is formed of a resin material composed primarily of polyurethane or polyurea. The outermost layer of the cover is referred to herein as the “cover layer.”

Referring to FIG. 1, the golf ball G of the invention has, for example, a core 1, an intermediate layer 2 and a cover layer (outermost layer) 3. The surface of the cover layer 3 has numerous dimples D formed thereon. Also, a colored surface portion 3a obtained by coloring the surface of the cover layer 3 is present at the cover layer surface. As shown in FIG. 1, this colored surface portion 3a is provided so as to be substantially uniform to a given depth from the surface of the cover layer 3 and toward the ball center.

The core is generally obtained by vulcanizing a rubber composition composed primarily of a base rubber. The core may be formed using, as this rubber composition, one which includes, for example, a base rubber, a co-crosslinking agent, a crosslinking initiator, a metal oxide and art antioxidant. Polybutadiene is preferably used as the base rubber of this rubber composition.

The polyurethane or polyurea serving as the resin material of the cover layer is described in detail below.

### Polyurethane

The polyurethane has a structure which includes soft segments composed of a polymeric polyol (polymeric glycol) that is a long-chain polyol, and hard segments composed of a chain extender and a polyisocyanate. Here, the polymeric polyol serving as a starting material may be any that has hitherto been used in the art relating to polyurethane materials, and is not particularly limited. This is exemplified by polyester polyols, polyether polyols, polycarbonate polyols, polyester polycarbonate polyols, polyolefin polyols, conjugated diene polymer-based polyols, castor oil-based polyols, silicone-based polyols and vinyl polymer-based polyols. Specific examples of polyester polyols that may be used include adipate-type polyols such as polyethylene adipate glycol, polypropylene adipate glycol, polybutadiene adipate glycol and polyhexamethylene adipate glycol; and lactone-type polyols such as polycaprolactone polyol. Examples of polyether polyols include poly ethylene glycol), polypropylene glycol), poly(tetramethylene glycol) and poly(methyl tetramethylene glycol).

The long-chain polyol preferably has a number-average molecular weight in the range of 1,000 to 5,000. By using a long-chain polyol having a number-average molecular weight in this range, golf balls made with a polyurethane composition that have excellent properties, including a good rebound and a good productivity, can be reliably obtained. The number-average molecular weight of the long-chain polyol is more preferably in the range of 1,500 to 4,000, and even more preferably in the range of 1,700 to 3,500.

Here and below, “number-average molecular weight” refers to the number-average molecular weight calculated based on the hydroxyl value measured in accordance with JIS-K1557.

The chain extender is not particularly limited; any chain extender that has hitherto been employed in the art relating to polyurethanes may be suitably used. In this invention, low-molecular-weight compounds with a molecular weight of 2,000 or less which have on the molecule two or more active hydrogen atoms capable of reacting with isocyanate groups may be used. Of these, preferred use can be made of aliphatic enols having from 2 to 12 carbon atoms. Specific examples include 1,4-butylene glycol, 1,2-ethylene glycol, 1,3-butanediol, 1,6-hexanediol and 2,2-dimethyl-1,3-propanediol. Of these, the use of 1,4-butylene glycol is especially preferred.

Any polyisocyanate hitherto employed in the art relating to polyurethanes may be suitably used without particular limitation as the polyisocyanate. For example, use can be made of one or more selected from the group consisting of 4,4′-diphenylmethane diisocyanate, 2,4-toluene diisocyanate, 2,6-toluene diisocyanate, p-phenylene diisocyanate, xylylene diisocyanate, 1,5-naphthylene diisocyanate, tetramethylxylene diisocyanate, hydrogenated xylylene diisocyanate, dicyclohexylmethane diisocyanate, tetramethylene diisocyanate, hexamethylene diisocyanate, isophorone diisocyanate, norbornene diisocyanate, trimethylhexamethylene diisocyanate, 1,4-bis(isocyanatomethyl)cyclohexane and dimer acid diisocyanate.

The ratio of active hydrogen atoms to isocyanate groups in the polyurethane-forming reaction may be suitably adjusted within a preferred range. Specifically, in preparing a polyurethane by reacting the above long-chain polyol, polyisocyanate and chain extender, it is preferable to use the respective components in proportions such that the amount of isocyanate groups included in the polyisocyanate per mole of active hydrogen atoms on the long-chain polyol and the chain extender is from 0.95 to 1.05 moles.

The method of preparing the polyurethane is not particularly limited. Preparation using the long-chain polyol, chain extender and polyisocyanate may be carried out by either a prepolymer process or a one-shot process via a known urethane-forming reaction. Of these, melt polymerization in the substantial absence of solvent is preferred. Production by continuous melt polymerization using a multiple screw extruder is especially preferred.

It is preferable to use a thermoplastic polyurethane material as the polyurethane. The thermoplastic polyurethane material may be a commercial product, examples of which include those available under the trade name Pandex from DIC Covestro Polymer, Ltd., and those available under the trade name Resamine from Dainichiseika Color & Chemicals Mfg. Co., Ltd.

### Polyurea

The polyurea is a resin composition composed primarily of urea linkages formed by reacting (i) an isocyanate with (ii) an amine-terminated compound. This resin composition is described in detail below.

### (i) Isocyanate

Suitable use can be made here of an isocyanate that is employed in the prior art relating to polyurethanes, although the isocyanate is not particularly limited. Use may be made of isocyanates similar to those described above in connection with the polyurethane material.

### (ii) Amine-Terminated Compound

An amine-terminated compound is a compound having an amino group at the end of the molecular chain. In this invention, the long-chain polyamines and/or amine curing agents shown below may be used.

A long-chain polyamine is an amine compound which has on the molecule at least two amino groups capable of reacting with isocyanate groups, and which has a number-average molecular weight of from 1,000 to 5,000. In this invention, the number-average molecular weight is more preferably from 1,500 to 4,000, and even more preferably from 1,900 to 3,000. Examples of such long-chain polyamines include, but are not limited to, amine-terminated hydrocarbons, amine-terminated polyethers, amine-terminated polyesters, amine-terminated polycarbonates, amine-terminated polycaprolactones, and mixtures thereof. These long-chain polyamines may be used singly, or two or more may be used in combination.

An amine curing agent is an amine compound which has on the molecule at least two amino groups capable of reacting with isocyanate groups, and which has a number-average molecular weight of less than 1,000. In this invention, the number-average molecular weight is more preferably less than 800, and even more preferably less than 600. Specific examples of such amine curing agents include, but are not limited to, ethylenediamine, hexamethylenediamine, 1-methyl-2,6-cyclohexyldiamine, tetrahydroxypropylene ethylenediamine, 2,2,4- and 2,4,4-trimethyl-1,6-hexanediamine, 4,4′-bis(sec-butylamino)dicyclohexylmethane, 1,4-bis(sec-butylamino)cyclohexane, 1,2-bis(sec-butylamino)cyclohexane, derivatives of 4,4′-bis(sec-butylamino)dicyclohexylmethane, 4,4′-dicyclohexylmethanediamine, 1,4-cyclohexane bis(methylamine) 1,3-cyclohexane bis(methylamine), diethylene glycol di(aminopropyl) ether, 2-methylpentamethylenediamine, diaminocyclohexane, diethylenetriamine, triethylenetetramine, tetraethylenepentamine, propylenediamine, 1,3-diaminopropane, dimethylaminopropylamine, diethylaminopropylamine, dipropylenetriamine, imidobis(propylamine), monoethanolamine, diethanolamine, triethanolamine, monoisopropanolamine, diisopropanolamine, isophoronediamine, 4,4′-methylenebis(2-chloroniline), 3,5-dimethylthio-2,4-toluenediamine, 3,5-dimethylthio-2,6-toluenediamine, 3,5-diethylthio-2,4-toluenediamine, 3,5-diethylthio-2,6-toluenediamine, 4,4′bis(sec-butylamino)diphenylmethane and derivatives thereof, 1,4-bis(sec-butylamino)benzene, 1,2-bis(sec-butylamino)benzene, N,N′-dialkylaminodiphenylmethane, N,N,N′,N′-tetrakis(2-hydroxypropyl)ethylenediamine, trimethylene glycol di-p-aminobenzoate, polytetramethylene oxide di-p-aminobenzoate, 4,4′-methylenebis(3-chloro-2,6-diethyleneaniline), 4,4′-methylenebis(2,6-diethylaniline), m-phenylenediamine, p-phenylenediamine and mixtures thereof. These amine curing agents may be used singly or two or more may be used in combination.

(iii) Polyol

Although not an essential ingredient, in addition to the above-described components (i) and (ii), a polyol may also be included in the polyurea. The polyol is not particularly limited, but is preferably one that has hitherto been used in the art relating to polyurethanes. Specific examples include the long-chain polyols and/or polyol curing agents mentioned below.

The long-chain polyol may be any that has hitherto been used in the art relating to polyurethanes. Examples include, but are not limited to, polyester polyols, polyether polyols, polycarbonate polyols, polyester polycarbonate polyols, polyolefin-based polyols, conjugated diene polymer-based polyols, castor oil-based polyols, silicone-based polyols and vinyl polymer-based polyols. These long-chain polyols may be used sin ply or two or more may be used in combination.

The long-chain polyol has a number-average molecular weight of preferably from 1,000 to 5,000, and more preferably from 1,700 to 3,500. In this average molecular weight range, an even better rebound and productivity are obtained.

The polyol curing agent is preferably one that has hitherto been used in the art relating to polyurethanes, but is not subject to any particular limitation. In this invention, use may be made of a low-molecular-weight compound having on the molecule at least two active hydrogen atoms capable of reacting with isocyanate groups, and having a molecular weight of less than 1,000. Of these, the use of aliphatic dials having from 2 to 12 carbon atoms is preferred. Specific examples include 1,4-butylene glycol, 1,2-ethylene glycol, 1,3-butanediol, 1,6-hexanediol and 2,2-dimethyl-1,3-propanediol. The use of 1,4-butylene glycol is especially preferred. The polyol curing agent has a number-average molecular weight of preferably less than 800, and more preferably less than 600.

A known method may be used to produce the polyurea. A prepolymer process, a one-shot process or some other known method may be suitably selected for this purpose.

The content of the above polyurethane or polyurea is suitably selected according to the required properties of the desired manufactured article, but is preferably at least 50 wt %, more preferably at least 60 wt %, and even more preferably at least 80 wt %, per 100 wt % of the overall resin composition that forms the cover layer. Resin materials other than polyurethane or polyurea may also be included in the resin composition that forms the cover layer, the purpose of these being to, for example, further enhance the flowability of the golf ball resin composition, or to increase various properties of the golf ball such as the rebound and scuff resistance.

In addition, optional additives may be suitably included in the cover-forming resin composition. For example, inorganic fillers, organic staple fibers, reinforcing agents, crosslinking agents, pigments, dispersants, antioxidants, ultraviolet absorbers and light stabilizers may be added to the above ingredients. When such additives are included, the amount thereof per 100 parts by weight of the base resin is preferably at least 0.1 part by weight, and more preferably at least 0.5 part by weight. The upper limit is preferably not more than 10 parts by weight, and more preferably not more than 4 parts by weight.

The method of molding the cover layer is not particularly limited. Such molding may be carried out by injection molding, compression molding, casting, reaction injection molding (RIM) or some other known molding method. For example, the cover layer may be molded by feeding the above cover layer-forming resin composition into an injection molding machine and injecting the molten resin composition over a core or other target sphere (e.g., the sphere obtained by encasing the core with an intermediate layer). In this case, the molding temperature differs depending on the type of polyurethane or polyurea serving as the base resin, but is typically in the range of 150 to 270° C.

The thickness of the cover layer is suitably selected according to the construction of the target golf ball, such as a two-piece golf ball or a three-piece golf ball. The thickness of this cover layer has an upper limit of generally not more than 3.0 mm, preferably not more than 2.0 mm, and more preferably not more than 1.5 mm. As for the lower limit in the thickness, a relatively thin cover layer results in a better spin performance on shots with a driver, but the scuff resistance worsens as the cover layer becomes thinner. Hence, to strike a good balance between both of these properties, the cover layer thickness has a lower limit of preferably at least 0.4 mm, more preferably at least 0.5 of mm, and even more preferably at least 0.6 mm.

The material hardness of the cover layer-forming resin composition is suitably selected according to the spin properties and scuff resistance achievable by the golf ball. The material hardness, expressed on the Shore D hardness scale, is preferably not more than 60, more preferably not more than 55, and most preferably not more than 45. This is because both a high resin material transparency and a high spin performance can be obtained at a relatively low hardness. From the standpoint of moldability, the lower limit in the Shore D hardness is preferably at least 25, and more preferably at least 30.

Numerous dimples are generally provided on the surface of the layer serving as the outermost layer of the golf ball for reasons having to do with the aerodynamic performance of the ball. The number of dimples formed on the cover surface is not particularly limited. However, to enhance the aerodynamic performance and increase the distance traveled by the ball, the number of dimples is typically from 250 to 400.

The golf ball of the invention has a colored surface portion obtained by coloring the surface of the cover layer. This colored surface portion exists within 1.0 mm, preferably within 0.5 mm, more preferably within 0.4 mm, and most preferably within 0.3 mm, of the surface of the cover layer (i.e., the surface of the lands, or dimple-free areas, on the cover layer). When the thickness of the colored surface portion from the surface of the cover layer is greater than 1.0 mm, the light transmittance of the cover layer becomes low, as a result of which it may not be possible to manifest the distinctive aesthetic appearance intended by this invention.

Next, the method of forming this colored surface portion is described.

Formation of the colored surface portion involves coloration to a given tone of the cover layer from the surface to a given inside region by a means for coloring the cover layer surface. Examples of this coloring means include infiltrating the cover layer with a colorant that is a pigment or a dye, inducing color development by causing an additive included in the resin composition of the cover layer to chemically react with a coating used for surface protection, and inducing by some external factor an additive included in the resin composition of the cover layer to undergo color development from the core layer surface.

The pigment or dye serving as the colorant is not particularly limited. Specific examples include light-harvesting pink dyes, light-harvesting red dyes, solvent yellow dyes, solvent orange dyes, anthraquinone dyes, solvent red dyes, solvent blue dyes, solvent black dyes, phthalocyanine dyes, azo dyes, nitro dyes, inorganic pigments such as ultramarine, yellow fluorescent pigments, pink fluorescent pigments and orange fluorescent pigments. Commonly known commercial products, such as those available under the product names Rheomine (Toga Senryo Co., Ltd.) and DYLON MULTI (Pylon Japan), may be used.

The coloring solution can be prepared by mixing from about 0.1 g to about 1.0 g of a pigment or dye as the colorant with 100 g of a solvent component such as water or alcohol. The amount of colorant used, although not particularly limited, may be the amount required to bring out the desired color tone. Common salt or another ingredient may he included as a catalyst in the coloring solution.

The means for infiltrating the cover layer with a colorant preferably entails using a coloring solution and coloring the surface of the cover layer with the coloring solution. The coloring solution used in this case is exemplified by dispersions of a pigment or dye in a solvent and by aqueous or oil-based coatings. To obtain the desired colorability at the cover surface, the temperature of the coloring solution when coloring the surface of the cover layer with the coloring solution is preferably not more than 100° C., more preferably from 20 to 80° C., even more preferably from 30 to 70° C., and most preferably from 40 to 60° C. Suitable selection of the coloring solution temperature, in combination with the coloring solution contact time, enables the intensity of the color tone in the colored surface portion to be adjusted at will.

The coloring solution contact time when coloring the surface of the cover layer with the coloring solution is preferably 24 hours or less, more preferably 20 hours or less, even more preferably 10 hours or less, and most preferably 5 hours or less. The lower limit value is at least one minute. When the contact time is too long, the cover surface colorability rises, but the golf ball production time increases, which is not industrially useful. Suitable selection of the coloring solution contact time, in combination with the coloring solution temperature, enables the intensity of the color tone in the colored surface portion to be adjusted at will.

The coloring solution used is preferably one obtained by dissolving or dispersing a dye in a solvent. In this case, the solvent used is exemplified by water and alcohol.

The step of providing the colored surface portion may include, after coloring the surface of the cover layer with the coloring solution, the step of removing excess coloring solution with a solvent. The solvent used for this purpose is preferably water or an alcohol. Various methods may be used without particular limitation as the means for removing excess coloring solution with a solvent. Preferred examples include removing excess coloring solution by spraying a solvent, removing excess coloring solution by immersion in a cleaning fluid of solvent alone, or wiping away excess solvent with a solvent-impregnated sponge or cloth.

A drying step may be provided in order to dry solvent remaining on the surface of the sphere that includes a cover layer where a colored surface portion has been formed. Such a drying step may be carried out at preferably up to 100° C., more preferably from 20 to 80° C., even more preferably from 30 to 70° C., and most preferably from 40 to 60° C., for a length of time that allows the residual solvent to fully dry, this being preferably at least 1 hour, and more preferably at least 3 hours, using any suitable known apparatus, such as a Geer oven, a special-purpose drying oven, a dehumidifying dryer or a vacuum dryer.

In order for the golf ball to exhibit the distinctive aesthetic appearance that is desired in this invention, it is critical for the visible light transmittance of the cover layer which includes the colored surface portion to be at least 0.6%. This value is preferably at least 0.8%, more preferably at least 1.0%, and even more preferably at least 3.0%. To keep the surface color of the core, intermediate layer-encased sphere or the like underlying, the cover layer from showing through and preventing the aesthetic appearance desired of the ball surface color from being obtained, the upper limit value in the visible light transmittance is preferably not more than 80%, more preferably not more than 50%, and most preferably not more than 20%. In this invention, the visible light transmittance of the cover layer can be measured using a commercial spectrophotometer in accordance with JIS K 0115. The visible light transmittance of the cover layer proper can be measured by peeling the cover layer that is the object of measurement from the golf ball, cutting out a thin strip in the shape in which measurement samples are mounted in the measuring instrument to be used and mounting the strip in the instrument.

The golf ball having a cover layer that includes the above colored surface portion has a lightness (L* value) in the L*a*b* color space of JIS Z8781 that is preferably at least 25, more preferably at least 30, even more preferably at least 40, and more preferably at least 50. When this value is high, the cover layer has a bright color; when it is low, the cover layer has a dark color.

In the practice of this invention, a coat may be applied to the surface of the cover layer that includes the above colored surface portion. The coating used when applying a coat to the surface of the cover layer is preferably a two-part curable urethane coating. The two-part curable urethane coating in this case includes a base resin composed primarily of a polyol resin and a curing agent composed primarily of a polyisocyanate. Such a coat is also called a clear coat.

When the coating is a two-part curable urethane coating, it is preferable to use as the base resin any of various polyols, such as saturated polyester polyols, acrylic polyols and polycarbonate polyols. It is also preferable to use as the isocyanate curing agent a non-yellowing polyisocyanate, examples of which include adducts, biurets, isocyanurates and mixtures thereof of hexamethylene diisocyanate, isophorone diisocyanate, hydrogenated xylylene diisocyanate and the like.

The coating contains the above resin as the base, to which various solvents and additives are suitably added, and may also include an effect pigment. When an effect pigment is used, it is preferable for the content of the effect pigment per 100 parts by weight of the base resin to be in the range of 1.0 to 10.0 parts by weight. When this content is too high, the ability of the spray gun to propel the coating material during spray painting decreases, which may make the coating operation more difficult to carry out. When the content is too low, the desired ball appearance may not be obtained,

Effect pigments are broadly divided into metal oxide-coated mica, basic lead carbonate, bismuth oxychloride and natural pearl essence. Of these, the selection of a metal oxide-coated mica is preferred because such pigments are nontoxic and have the best chemical stability. In general, titanium dioxide and iron oxide are commonly used as the metal oxide. By varying the coverage (thickness of the metal oxide coat), various colors and interference effects can be achieved. The larger the particle size of such pigments, the greater the degree of luster that can be achieved. However, at larger pigment particle sizes, the luster tends to subside. It is therefore necessary to select a pigment having a suitable particle size.

A golf ball that has been coated with a coating containing such an effect pigment is able to reflect light in many directions, increasing the quality feel of the ball. Moreover, because it filly reflects sunlight, the golf ball is easier to find.

The golf ball can also be fashioned into a ball having a so-called matte feel without luster by including delustering particles in the coating composition. The delustering particles used in this case are exemplified by silica particles, melamine particles and acrylic particles. Specific examples include particles made of silica, polymethyl methacrylate, polybutyl methacrylate, polystyrene or polybutyl acrylate. The particles may be either organic or inorganic particles, with the use of silica particles being especially preferred.

The content of delustering particles may be set to preferably from 5 to 10 parts by weight per 100 parts by weight of the base resin (combined amount of resin component and solvent) of the coating composition. When the content is too high, the viscosity of the coating composition rises, which tends to make the coating more difficult to apply. When the content is too low, the light-quenching effect may decrease.

A known method may be used without particular limitation as the method for applying the above coating onto the surface of the cover layer. Use can be made of a desired method, such as air-gun painting or electrostatic painting.

The thickness of the coating layer applied onto the cover layer, although not particularly limited, is generally from 8 to 22 μm, and preferably from 10 to 20 μm.

The weight, diameter and other ball specifications of the inventive golf ball may be suitably set in accordance with the Rules of Golf.

### EXAMPLES

The following Examples and Comparative Examples are provided to illustrate the invention, and are not intended to limit the scope thereof.

### Examples 1 to 50, Comparative Examples 1 to 8

A core-forming rubber composition formulated as shown in Table 1 and common to all of the Examples was prepared and then molded and vulcanized to produce a 38.6 mm diameter core.

TABLE 1

| Rubber composition | parts by weight |
|---|---|
| cis-1,4-Polybutadiene | 100 |
| Zinc acrylate | 27 |
| Zinc oxide | 4.0 |
| Barium sulfate | 16.5 |
| Antioxidant | 0.2 |
| Organic peruxide (1) | 0.6 |
| Organic peroxide (2) | 1.2 |
| Zinc salt of pentachlorothiophenol | 0.3 |
| Zinc stearate | 1.0 |

Details on the ingredients in the core material are given below.
cis-1,4-Polybutadiene: Available under the trade name “BR 01” from JSR Corporation
Zinc acrylate: Available from Nippon Shokubai Co., Ltd.
Zinc oxide: Available from Sakai Chemical Co., Ltd.
Barium sulfate: Available from Sakai Chemical Co., Ltd.
Antioxidant: Available under the trade name “Noerac NS6” from Ouchi Shinko Chemical industry Co., Ltd.
Organic peroxide (1): Dicumyl peroxide, available under the trade name “Percumyl D” from NOF Corporation
Organic peroxide (2): A mixture of 1,1-di(tert-butylperoxy)cyclohexane and silica, available under the trade name “Perhexa C-40” from NOF Corporation
Zinc stearate: Available from NOF Corporation

Next, an intermediate layer-forming resin material common to all of the Examples was prepared. This intermediate layer-forming resin material was a blend of 50 parts by weight of a sodium neutralization product of an ethylene-unsaturated carboxylic acid copolymer having an acid content of 18 wt % and 50 parts by weight of a zinc neutralization product of an ethylene-unsaturated carboxylic acid copolymer having an acid content of 15 wt %, for a total of 100 parts by weight. This resin material was injection-molded over the 38.6 mm diameter core obtained as described above, thereby producing a white intermediate layer-encased sphere having a 1.25 mm thick intermediate layer.

The cover layer-forming resin materials for the respective Examples shown in Tables 3, 4 and 5 below were then injection-molded over the intermediate layer-encased sphere, thereby producing uncoated golf balls (diameter, 42.7 mm) having a 0.8 mm thick cover layer (outermost layer). Dimples common to all the Examples were formed at this time on the cover surface of the balls in the respective Examples and Comparative Examples.

### Method of Forming Colored Surface Portion

Using dyes having the commercial product name DYLON MULTI (Dylon Japan) as the colorants, coloring solutions were prepared by adding 0.5 g of the colorant to 100 mL of water and stirring, following which the uncoated golf balls were dipped in these coloring solutions so as to be entirely immersed. The respective balls were immersed in the coloring solutions containing the colorants (color No.) shown in Tables 3 to 5 below at the temperature and for the length of time indicated for each Example and Comparative Example. The golf balls were then taken out of the coloring solutions and rinsed with water, following which they were dried at 55° C. for 3 hours in a Geer oven, thereby giving in each Example an uncoated golf ball whose surface was colored to the desired color tone.

### Depth of Penetration by Coloring Solution

A cross-section of the cover layer that had been immersed in coloring solution was examined with a digital microscope, and the straight-line distance across the colored region from the surface was measured. Measurements were taken in ten randomly selected places, and the average of these measurements was calculated. When there were stepwise gradations in the color, the distance across the most intensely colored region was measured. A value of 0 was assigned in cases where there was no coloration by the coloring solution and a value of 1 was assigned in cases where the cover layer surface was entirely colored, and the average of these values was indicated in millimeter (mm) units.

The golf balls in the respective Examples and Comparative Examples were then coated to a thickness of 15 μm on the cover layer surface using the four types of coatings made of a base resin and a curing agent shown in Table 2 below (Clear Coating, Pearl Coating, Matte Coating and Matte/Pearl Coating), thereby forming a coating layer.

TABLE 2

| Paint composition (pbw) | | Clear | Pearl | Matte | Matte/Pearl |
|---|---|---|---|---|---|
| Base resin | Polyol | 27.5 | 27.5 | 17.5 | 27.5 |
| | Effect pigment | | 6.0 | | 6.0 |
| | Delustering particles | | | 9.0 | 9.0 |
| | Solvent | 72.5 | 72.5 | 72.5 | 72.5 |
| Curing agent | HDI isocyanurate | 42 | 42 | 42 | 42 |
| | Solvent | 58 | 58 | 58 | 58 |

Details on the ingredients in the table are given below.
Polyol: A saturated polyester polyol; weight-average molecular weight (Mw), 28,000; acid value, 4; hydroxyl value, 170
Effect pigment: Natural mica (Iriodin 7205, from Sano Paint Co., Ltd.)
Delustering particles: Silica (Finesil X-35, from Marco Calcium Co., Ltd,: average primary particle size, 2.4 μm; BET specific surface area, 262 m²/g)
HDI isocyanurate: Available as Duranate™ TPA-100 from Asahi Kasei Corporation; NCO content, 23.1 wt %; nonvolatiles content, 100 wt %
Solvent: Ethyl acetate was used as the base resin solvent; ethyl acetate and butyl acetate were used as the curing agent solvents

Details on the polyurethane resins used in the resin materials for the cover layer are shown below.
TPU 1: An ether-type thermoplastic polyurethane available from DIC Covestro Polymer, Ltd. under the trade name “Pandex” (Shore D hardness, 40); uncolored product
TPU 2: An ether-type thermoplastic polyurethane available from DIC Covestro Polymer, Ltd. under the trade name “Pandex” (Shore D hardness, 40); white-colored product
TPU 3: An ether-type thermoplastic polyurethane available from DIC Covestro Polymer, Ltd. under the trade name “Pandex” (Shore D hardness, 40); yellow-colored product.
TPU 4: An ether-type thermoplastic polyurethane available from DIC Covestro Polymer, Ltd. under the trade name “Pandex” (Shore D hardness, 40); orange-colored product
TPU 5: An ether-type thermoplastic polyurethane available from DIC Covestro Polymer, Ltd. under the trade name “Pandex” (Shore D hardness, 40); black-colored product
TPU 6: An ether-type thermoplastic polyurethane available from DIC Covestro Polymer, Ltd. under the trade ane “Pandex” (Shore D hardness, 60); uncolored product

The light transmittance and lightness (L* value) of the resulting cover layer in each of the Examples and Comparative Examples, and the visibility, distinctive aesthetic appearance (Kawaii level) and spin performance on approach shots of the golf ball were evaluated according to the following criteria. The results are presented in Tables 3 to 5.

### Visible Liuht Transmittance of Cover Layer

The light transmittance (T %) was measured using the UV-1800 ultraviolet-visible spectrophotometer (Shimadzu Corporation). The cover layer was peeled from a coated ball produced as described above and measurement was carried out using as the measurement sample a thin strip cut from the cover layer. Regarding the light path during measurement, measurement was carried out from the surface side of the cover layer and the slit width was set to 0.1 nm. The average value was determined alter data sampling at a 1-nm pitch in the wavelength range of 380 to 780 nm.

### L* Value (Lightness)

The lightness (L* value) was determined based on the L*a*b* color space in JIS Z8781 by measurement using a color difference meter (model SC-P, from Suga Test Instruments Co., Ltd.). A larger value indicates a lighter color tone. In the practice of the invention, the coated ball was set in the instrument and measured. Hence what was being measured was the appearance of the ball itself.

### Evaluation of Ball Appearance (Kawaii Level)

Ten golfers carried out sensory evaluations of the golf balls in each Example on the following five-point scale.

Score

1 point: Appearance is ordinary; ball does not feel cute.

2 points: Ball feels somewhat cute and okay to use.

3 points: Ball feels cute and appearance is good; would like to try using.

4 points: Ball feels very cute and appearance is very good; would like to use.

5 points; Ball feels really cute and appearance is especially good; would very much like to use.

### Ball Visibility

Ten skilled amateur golfers carried out sensory evaluations of the golf balls in each Example on the ease of seeing the trajectory of the ball when hit with a driver (W#1) in fair weather. The evaluations were carried out based on the following criteria.

Exc: Eight or more of ten golfers felt that ball trajectory when hit was easy to see.

Good: Five to seven of ten golfers felt that ball trajectory when hit was easy to see.

Fair: Three or four of ten golfers felt that ball trajectory when hit was easy to see.

NG: Two or fewer of ten golfers felt that bill trajectory when hit was easy to see.

### Surface Hardness of Ball

The surface hardness of the ball in each Example was measured with a JIS-C durometer by perpendicularly pressing the indenter of the durometer against the ball surface. The surface hardness of a ball (the surface hardness of the cover) is a measured value obtained at a land (non-dimple) area on the ball surface.

### Spin Performance on Approach Shots

A sand wedge (SW) was mounted on a golf swing robot and the rate of backspin by the ball immediately after being struck at a bead speed (HS) of 11 m/s was measured with an apparatus for measuring the initial conditions.

TABLE 3

| | Example | | | | | | | | |
|---|---|---|---|---|---|---|---|---|---|
| | 1 | 2 | 3 | 4 | 5 | 6 | 7 | 8 | 9 |
| Cover resin or ball name | TPU1 | TPU1 | TPU1 | TPU1 | TPU1 | TPU1 | TPU1 | TPU1 | TPU1 |
| Colorant: DYLON MULTI color No. | No.12 | No.15 | No.25 | No.26 | No.32 | No.33 | No.39 | No.12 | No.15 |
| Coloring solution immersion temperature (° C.) | 55 | 55 | 55 | 55 | 55 | 55 | 55 | 55 | 55 |
| Coloring solution immersion time (min) | 30 | 30 | 30 | 30 | 30 | 30 | 30 | 180 | 180 |
| Coating | clear | clear | clear | clear | clear | clear | clear | clear | clear |
| Visible light transmittance T (%) | 11.2 | 8.0 | 11.2 | 9.7 | 10.9 | 9.4 | 11.1 | 10.3 | 8.2 |
| Depth of infiltration (mm) | 0.10 | 0.10 | 0.10 | 0.09 | 0.08 | 0.10 | 0.09 | 0.24 | 0.32 |
| Lightness (L*) | 85.3 | 73.4 | 89.0 | 72.9 | 78.5 | 86.1 | 86.8 | 66.6 | 50.3 |
| Kawaii level (KWI score) | 4.0 | 4.0 | 3.5 | 2.6 | 4.4 | 4.0 | 4.4 | 3.5 | 3.5 |
| Visibility | Exc | Exc | Exc | good | Exc | Exc | Exc | Exc | good |
| Ball surface hardness (JIS-C hardness) | 82 | 82 | 82 | 82 | 82 | 82 | 82 | 82 | 82 |
| Spin rate on 15 yard approach shot (rpm) | 5,089 | 5,095 | 5,081 | 5,080 | 5,102 | 5,079 | 5,088 | 5,097 | 5,073 |
| | Example | | | | | | Comparative Example | | |
| | 10 | 11 | 12 | 13 | 14 | 15 | 1 | 2 | 3 |
| Cover resin or ball name | TPU1 | TPU1 | TPU1 | TPU1 | TPU1 | TPU6 | Commercial | TPU2 | TPU5 |
| | | | | | | | name (1) | | |
| Colorant: DYLON MULTI color No. | No.25 | No.26 | No.32 | No.33 | No.39 | No.12 | — | — | — |
| Coloring solution immersion temperature (° C.) | 55 | 55 | 55 | 55 | 55 | 55 | — | — | — |
| Coloring solution immersion time (min) | 180 | 180 | 180 | 180 | 180 | 180 | — | — | — |
| Coating | clear | clear | dear | clear | clear | clear | clear | clear | clear |
| Visible light transmittance T (%) | 11.4 | 9.4 | 8.0 | 9.3 | 10.0 | 9.9 | 0.0 | 0.0 | 0.0 |
| Depth of infiltration (mm) | 0.20 | 0.17 | 0.20 | 0.28 | 0.23 | 0.19 | 1.00 | 1.00 | 1.00 |
| Lightness (L*) | 77.4 | 39.1 | 55.4 | 72.6 | 70.6 | 73.9 | 88.9 | 88.6 | 20.5 |
| Kawaii level (KWI score) | 4.4 | 1.7 | 4.0 | 4.4 | 2.6 | 3.5 | 0.8 | 0.8 | 1.2 |
| Visibility | Exc | fair | Exc | good | Exc | Exc | Exc | Exc | NG |
| Ball surface hardness (JIS-C hardness) | 82 | 82 | 89 | 82 | 82 | 92 | 89 | 82 | 82 |
| Spin rate on 15 yard approach shot (rpm) | 5,108 | 5,102 | 5,086 | 5,099 | 5,069 | 4,328 | 4,879 | 5,069 | 5,052 |

Commercial name (1): Trade name-Titleist ProV1 (2019 model) (product of Acuslmet Co.)

TABLE 4

| | Example | | | | | | | | |
|---|---|---|---|---|---|---|---|---|---|
| | 16 | 17 | 18 | 19 | 20 | 21 | 22 | 23 | 24 |
| Cover resin or ball name | TPU1 | TPU1 | TPU1 | TPU1 | TPU1 | TPU1 | TPU1 | TPU1 | TPU1 |
| Colorant: DYLON MULTI color No. | No.12 | No.15 | No.25 | No.26 | No.32 | No.33 | No.39 | No.12 | No.15 |
| Coloring solution immersion temperature (° C.) | 55 | 55 | 55 | 55 | 55 | 55 | 55 | 55 | 55 |
| Coloring solution immersion time (min) | 30 | 30 | 30 | 30 | 30 | 30 | 30 | 180 | 180 |
| Coating | pearl | pearl | pearl | pearl | pearl | pearl | pearl | pearl | pearl |
| Visible light transmittance T (%) | 6.0 | 5.9 | 9.5 | 7.5 | 6.4 | 7.3 | 8.4 | 8.2 | 5.5 |
| Depth of infiltration (mm) | 0.10 | 0.10 | 0.10 | 0.09 | 0.08 | 0.10 | 0.09 | 0.24 | 0.32 |
| Lightness (L*) | 83.9 | 79.9 | 87.5 | 64.7 | 72.9 | 86.2 | 86.1 | 68.4 | 52.3 |
| Kawaii level (KWI score) | 4.4 | 4.4 | 4.4 | 4.4 | 4.4 | 4.4 | 4.4 | 4.0 | 4.4 |
| Visibility | Exc | Exc | Exc | good | Exc | Exc | Exc | Exc | good |
| | Example | | | | | Comparative Example | | | |
| | 25 | 26 | 27 | 28 | 29 | 4 | 5 | 6 | 7 |
| Cover resin or ball name | TPU1 | TPU1 | TPU1 | TPU1 | TPU1 | Commercial | TPU2 | TPU3 | TPU4 |
| | | | | | | name (2) | | | |
| Colorant: DYLON MULTI color No. | No.25 | No.26 | No.32 | No.33 | No.39 | — | — | — | — |
| Coloring solution immersion temperature (° C.) | 55 | 55 | 55 | 55 | 55 | — | — | — | — |
| Coloring solution immersion time (min) | 180 | 180 | 180 | 180 | 180 | — | — | — | — |
| Coating | pearl | pearl | pearl | pearl | pearl | pearl | pearl | pearl | pearl |
| Visible light transmittance T (%) | 6.0 | 4.4 | 6.3 | 6.8 | 6.3 | 0.5 | 0.0 | 0.5 | 0.6 |
| Depth of infiltration (mm) | 0.20 | 0.17 | 0.20 | 0.28 | 0.23 | 1.00 | 1.00 | 1.00 | 1.00 |
| Lightness (L*) | 75.9 | 42.1 | 55.8 | 72.1 | 71.0 | 94.7 | 88.0 | 97.9 | 62.3 |
| Kawaii level (KWI score) | 4.4 | 3.0 | 4.0 | 4.4 | 3.5 | 1.2 | 1.2 | 1.2 | 1.2 |
| Visibility | Exc | fair | Exc | good | Exc | Exc | Exc | Exc | Exc |

Commercial name (2): Trade name-Titleist ProV1/Yellow (2019 model) (product of Acuslmet Co.)

TABLE 5

| | Example | | | | | | | | | | |
|---|---|---|---|---|---|---|---|---|---|---|---|
| | 30 | 31 | 32 | 33 | 34 | 35 | 36 | 37 | 38 | 39 | 40 |
| Cover resin or ball name | TPU1 | TPU1 | TPU1 | TPU1 | TPU1 | TPU1 | TPU1 | TPU1 | TPU1 | TPU1 | TPU1 |
| Colorant: DYLON MULTI | No.12 | No.15 | No.25 | No.26 | No.32 | No.33 | No.39 | No.12 | No.15 | No.25 | No.26 |
| color No. | | | | | | | | | | | |
| Coloring solution immersion | 55 | 55 | 55 | 55 | 55 | 55 | 55 | 55 | 55 | 55 | 55 |
| temperature (° C.) | | | | | | | | | | | |
| Coloring solution immersion | 30 | 30 | 30 | 30 | 30 | 30 | 30 | 180 | 180 | 180 | 180 |
| time (min) | | | | | | | | | | | |
| Coating | matte | matte | matte | matte | matte | matte | matte | matte | matte | matte | matte |
| Visible light transmittance T (%) | 4.5 | 3.7 | 3.5 | 3.2 | 3.8 | 3.8 | 3.9 | 3.9 | 3.8 | 4.2 | 3.1 |
| Depth of infiltration (mm) | 0.10 | 0.10 | 0.10 | 0.09 | 0.08 | 0.10 | 0.09 | 0.24 | 0.32 | 0.20 | 0.17 |
| Lightness (L*) | 84.4 | 77.6 | 88.2 | 63.3 | 70.1 | 86.3 | 84.9 | 68.8 | 53.3 | 80.1 | 39.9 |
| Kawaii level (KWI score) | 4.4 | 4.4 | 4.4 | 4.0 | 4.4 | 4.4 | 4.4 | 4.0 | 4.4 | 4.4 | 3.5 |
| Visibility | Exc | Exc | Exc | good | Exc | Exc | Exc | Exc | good | Exc | fair |
| | | | | Comp. | | | | | | | |
| | Example | | | Ex. | Example | | | | | | |
| | 41 | 42 | 43 | 8 | 44 | 45 | 46 | 47 | 48 | 49 | 50 |
| Cover resin or ball name | TPU1 | TPU1 | TPU1 | TPU2 | TPU1 | TPU1 | TPU1 | TPU1 | TPU1 | TPU1 | TPU1 |
| Colorant: DYLON MULTI | No.32 | No.33 | No.39 | — | No.12 | No.15 | No.25 | No.26 | No.32 | No.33 | No.39 |
| color No. | | | | | | | | | | | |
| Coloring solution immersion | 55 | 55 | 55 | — | 55 | 55 | 55 | 55 | 55 | 55 | 55 |
| temperature (° C.) | | | | | | | | | | | |
| Coloring solution immersion | 180 | 180 | 180 | — | 180 | 180 | 180 | 180 | 180 | 180 | 180 |
| time (min) | | | | | | | | | | | |
| Coating | matte | matte | matte | matte | matte | matte | matte | matte | matte | matte | matte |
| | | | | | pearl | pearl | pearl | pearl | pearl | pearl | pearl |
| Visible light transmittance T (%) | 3.5 | 3.9 | 4.0 | 0.0 | 1.2 | 1.3 | 1.5 | 0.8 | 1.2 | 1.5 | 1.3 |
| Depth of infiltration (mm) | 0.20 | 0.28 | 0.23 | 1.00 | 0.24 | 0.32 | 0.20 | 0.17 | 0.20 | 0.28 | 0.23 |
| Lightness (L*) | 54.3 | 76.9 | 74.0 | 88.8 | 71.6 | 60.3 | 79.9 | 55.0 | 61.8 | 76.1 | 74.3 |
| Kawaii level (KWI score) | 3.5 | 4.4 | 3.5 | 0.8 | 4.0 | 4.4 | 4.4 | 4.0 | 4.0 | 4.4 | 4.4 |
| Visibility | Exc | good | Exc | Exc | Exc | good | Exc | fair | Exc | fair | Exc |

The following is apparent from the evaluation results in Tables 3 to 5.

As demonstrated in the Examples, even though the cover layer was color-treated at the surface there was no change in the hardness of the cover layer overall. As a result, ball properties such as the spin performance can be maintained.

In cases where the hardness of the urethane resin material used in the cover layer differs, using a relatively soft resin material results in a ball appearance (impression) that has a high transparency and a clear appearance. Moreover, the spin properties are good and, because a polyurethane resin is used, the scuff resistance of the ball is also good.

It is apparent that when a coloring solution is made to penetrate from the cover layer surface, in balls where the depth of infiltration is relatively small (shallow), the transmittance, ball visibility and Kawaii level increase.

In cases where the lightness (L* value) is low even though the resin material in the cover layer has a high light transmittance, the ball visibility and Kawaii level decrease. Also, by using polyurethane as the resin material in the cover layer, the dye makes its way into the resin and can readily color-treat the cover layer surface. Although the cover layer is heated in order to dry it after the cover layer surface has been colored, because exposure to high-heat conditions on the order of the cover layer resin molding temperature is not necessary, discoloration does not occur and so color treatment to the desired color tone is possible.

Japanese Patent Application No. 2019-226473 is incorporated herein by reference.

Although some preferred embodiments have been described, many modifications and variations may be made thereto in light of the above teachings. It is therefore to be understood that the invention may be practiced otherwise than as specifically described without departing from the scope of the appended claims.

1. A golf ball comprising a cover layer that is formed of a resin material composed primarily of polyurethane or polyurea, wherein the ball has a colored surface portion obtained by coloring, a surface of the cover layer, and the cover layer which includes the colored surface portion has a visible light transmittance of at least 0.6%.

2. The golf ball of claim 1, wherein the colored surface portion obtained by coloring the cover layer surface has a color tone differing from that of the resin material making up the cover layer.

3. The golf ball having the colored surface portion-containing cover layer of claim 1, wherein the ball has a lightness (L* value) in the L*a*b* color space of at least 25.

4. The golf ball of claim 1, wherein the colored surface portion is colored with a dye.

5. The golf ball of claim 1, wherein the colored surface portion exists within 1.0 mm of the cover layer surface.

6. The golf ball of claim 1, wherein the resin material of the cover layer has a Shore D hardness of not more than 60.

7. A method for producing a golf ball having a cover layer that is formed of a resin material composed primarily of polyurethane or polyurea, which method comprises the steps of:
forming the cover layer over a core or other target sphere; and
providing a colored surface portion by coloring a surface of the cover layer, wherein the cover layer which includes the colored surface portion has a visible light transmittance of at least 0.6%.

8. The method of claim 7, wherein the step of providing a colored surface portion includes the step of coloring the surface of the cover layer with a coloring solution.

9. The method of claim 8 wherein, when coloring the surface of the cover layer with the coloring solution, the coloring solution has a temperature of not more than 100° C.

10. The method of claim 8 wherein, when coloring the surface of the cover layer with the coloring solution, the coloring solution has a contact time with the cover layer surface of from 1 minute to 24 hours.

11. The method of claim 8, wherein the coloring solution is obtained by dissolving or dispersing a dye in a solvent.

12. The method of claim 8, wherein the step of providing the colored surface portion includes, after coloring the surface of the cover layer with the coloring solution, the step of removing excess coloring solution with a solvent.

13. The method of claim 12, wherein the s nt used for removing excess coloring solution is water or an alcohol.
